(19) United States
(12) Patent Application Publication
(10) Pub. No.: US 2009/0136013 A1
(43) Pub. Date: May 28, 2009

(54) SYSTEM FOR OBTAINING INFORMATION REGARDING TELEPHONE CALLS

(76) Inventors: Peter A. Kuykendall, Menlo Park, CA (US); Ronald K. Tang, San Jose, CA (US); Paul Wayne Spencer, Fridley, MN (US)

Correspondence Address: FELDMANGALE, P.A., 1700 Market Street, Suite # 3130, Philadelphia, PA, 19103, US

(21) Appl. No.: 12/274,205

(22) Filed: Nov. 19, 2008

Related U.S. Application Data
(60) Provisional application No. 61/003,572, filed on Nov. 19, 2007.
(60) Provisional application No. 61/011,033, filed on Jan. 14, 2008.

(51) Int. Cl. H04M 1/56

(52) U.S. Cl. 379/142.17

(57) ABSTRACT

A system and method for gathering and presenting relevant information about another party to a telephone call are provided to a user who is making or receiving a telephone call. The information is sufficient to assist the user in deciding whether or not to accept a call, or to provide the user with sufficient context information to discuss the subject of the telephone call. The system also permits a user to enter new information, such as an appointment or a new task for a to-do list, send an e-mail to the other party, or update contact or other information regarding the other party. In one embodiment, the system assists telemarketers to track advertisements and messages intended to be presented to the other party to a telephone call.

### CROSS-REFERENCE TO RELATED APPLICATIONS

This application claims benefit under 35 U.S.C. § 119(e) of U.S. application Ser. No. 61/003,572, filed Nov. 19, 2007 and application Ser. No. 61/011,033, filed Jan. 14, 2008. Each of these applications is incorporated herein by reference in its entirety:

### BACKGROUND OF INVENTION

This invention provides a system and method for gathering and presenting relevant information to a person who is receiving a telephone (the “callee” or “user”) sufficient to assist the callee in deciding whether or not to accept the call. The collection and presentation of this information also helps the user maximize his conversation and relationship with the other party (the “caller”). For the purposes of this patent, the term “caller” refers to the other party of a call, whether the call is initiated or received by the user.

The increasingly widespread use of the telephone as an instrument of commercial advertising, or of charitable solicitation, or as a survey and marketing tool, has left private households at the mercy of the operators of such systems. Rare is the evening or weekend that is not spoiled by the intrusion of an unsolicited and unwanted telephone call in which the callee must either hang up in the middle of the caller's spiel, or listen and respond to an unwanted request for information or money. Less common, but arguably more unsettling, is the unwanted telephone call from a family member or other acquaintance to discuss a topic that may be distasteful or undesired by the callee. Possibly the most disconcerting is the business call from a dimly-recognized client or potential customer that catches the callee unprepared to discuss the caller's topic.

In an attempt to avoid such uncomfortable situations, telephone companies have long provided a means for the callee to determine the identity of the caller prior to answering the telephone call. Caller identification, also known as Automated Number Identification (ANI) or Originating Line Information (OLI), is now a staple of most telephone systems, and provides information about the telephone number from which the incoming call is originating, and frequently the name of the subscriber of that number. However, while such information may identify a caller, it does not provide context or any history that may be associated with the caller.

When the user is in a conversation and is using a mobile phone, there is a wealth of relationship, business and public information that could, if collected and presented, significantly assist the user during and after the conversation. With the information collected, the system provider could present targeted, contextual advertising on the user's telephone or desktop computer pertaining to the identity of the caller, the interests and needs of the user, or the topics of the conversation.

What is needed is a system that will automatically search for and retrieve relevant information on the fly during the time that a telephone call is being placed or connected, or that may be accessed by a user during the course of a telephone call.

### SUMMARY OF INVENTION

This invention is a system comprised of software application running on a telephone or a local computer (the “client”) which, upon receipt of a call from a caller (the “caller”), initiates a software query of a number of databases having information specific to a particular call or caller. A comprehensive database is maintained on a network server (the “server”), and is available to provide information about the call. Other databases may be maintained within the applications program on a local client, such as a personal computer, a telephone processing device, or some other platform for operating the application; or a native device, such as a cellular telephone, a PDA, or other, similar user-customized device, may maintain a database having relevant information.

The query to the database(s) will include the ANI (which is normally the originating phone number) and presents to the user (the “callee”) enough information that the callee (or the software running on his telephone or local computer) can decide to accept or reject the call. If the callee uses VOIP, the VOIP server can initiate the query to the server, which will process the request and then notify the client of its analysis of the incoming call.

The system stores a broad set of information that may be used to determine the recommended disposition of the call. Among the kinds of information that may be used for this purpose is:
(a) Heuristic information which has been saved from prior calls made to or from the same caller and user. For example, such information may include whether the caller only calls the user and not visa-versa; whether the user does or does not pick up the phone when the caller calls; whether the callee called the caller previously; and similar party-and-call-specific information.
(b) Explicitly saved information, such as blocked numbers, numbers in the Callee's address book, categorization of the caller (e.g., is the caller a family member, friend, or business associate?).
(c) Information about a phone number collected from outside public and private sources, such as social networks, phone number lists of telephone companies, or websites containing lists of telemarketer's numbers. This information may be collected and stored in advance by a spider or, in the case of social networks, may be requested from the social network at the time of the call.
(d) Meta-information about a caller saved by other users of the same service (e.g., many other callers identify a caller as a mortgage telemarketer).
(e) Meta-Information about the caller, such as the type of work that the caller performs. For example, a normal consumer callee may not want to accept a phone call from a mortgage broker, but a wholesale lender's employee might be happy to accept that call.
(f) The results of an analysis of some or all of the above information.

The server also collects other dynamic information that may be available about the call such as any telephony switching information (e.g., SS7 information) that is available, source IP number and IP block for VOIP call, time of day, and information that can be obtained by analyzing the numbers contained in the ANI, such as determining that a number is invalid (e.g., 000-000-0000), or is a toll free or local number, or identifying the owner or service provider for a number or a block of numbers. This information will be saved on the server in hashed tables, files and databases. Some information may also be saved on the client—the local computer or telephone.

The process of analyzing this information is an algorithm that evaluates the call based on factors such as those recited above, and then sends results to the client either all at one time or asynchronously, as results are returned from the algorithm. The analysis determines a ranking of the likelihood that the telephone call is from a person the callee wants to talk with. As used throughout this description, the term “value” when used to describe a property of a caller or of a call, refers only to the likelihood that the user may wish to speak with the caller or accept the call, and has nothing to do with an objective valuation of the worth or substance of the caller. In the analysis, certain factors will be assigned as blocking (such as explicitly blocked numbers) or accepting factors (such as emergency numbers), while other factors will have variable or offsetting importance. The analysis is also used to determine the likely scope or purpose of the call. The results of the analysis and a subset of the information saved information on the server will be sent to the client, as is described in greater detail, below. A subset of the analysis may be performed at the client (e.g., explicit call blocking). The notification and results of the analysis may be communicated to the server and saved for future analyses or for logging.

The call characterization information may be sent to the client device as an image or in XML, name-value pairs or some other easily parsable format. The information is presented to the user in graphical and picture or icon format. In a VOIP server environment, the results of the analysis may be sent to the VOIP server where they may be presented to, and acted upon by, the user, without the call, or notification of the call, having been sent to the telephone.

Acting upon this information, the callee can manually decide to accept a call, or program the client to pass the call to voice mail, or reject the call. The callee can also establish rules on the client that automatically route or terminate the call.

Upon the connection or completion of an inbound or outbound phone call, a form may be presented to the system user in which the user has the ability to explicitly provide meta-data that characterizes and displaces the just completed call. Call meta-data collected may include such information as the caller's name, the reason for the conversation, any actions that the parties have committed to do, whether a message was left, and how future calls from the same caller should be handled. This information may be saved and used for analyzing future calls as explained above.

Some information can be pre-filled in based on the phone's internal phone book or the server's knowledge of the call (e.g., the other party's name and business) or characteristics of the call. As an example of how call characteristics are determined, if the user initiates a call and reaches a voice-mail, the call is characterized as being to a voice-mail if the callee's answering machine talks at the beginning of the call and the caller talks at the end and then hangs up.

During a phone call, characterization information from the current call or prior calls can be used to present relevant information, including advertising, to the callee (e.g., when a car salesman is the caller, the system can present car financing options; or where the user enters a ‘to-do’ to “get skis,” the system can present advertisements for ski tickets).

In a preferred embodiment of the invention, at the start of a call, as the phone is ringing, the user may be presented with the standard contact information of name, number, position and organization about the caller and with 4 pieces of information:
(a) “User defined” tags, either defined by the user or by other users of the network.
(b) “Canned” tags, represented as either text or icons, referencing publicly or privately available information about the person, including the caller's relationship to a known group, such as the caller's belonging to, or being employed by, an organization or social network.
(c) “System” tags indicating actions such as whether the call should be blocked, or classified as spam, or recorded. Such tags may be automatically acted on by the telephone or computer system and may not be represented graphically in the incoming call screen.
(d) One or more Value Scales, consisting either of graphical or textual information, and showing the likely value of the phone call or the value or reputation of the caller.

“User defined tags” are identifying strings of text, created during or at the conclusion of a call, indicating something the callee thinks is important about the call. User tags are stored both locally on the client, for future retrieval, and are also sent to the server. From the server, they can be synchronized and sent to other clients of the same user. Furthermore, the tags sent to the server are processed and merged and may be sent back up to other users. The rules for which tags are sent up to other users are based on popularity, merging and exclusion rules (e.g., tags connoting a relationship, such as “mom” are excluded). Tags may also originate from the caller himself, or from the network where they were stored by other network users. Tags originating from other than the callee are represented, either graphically or through text, as “network based” (e.g., by being more opaque). Network tags can be deleted, overwritten or negated by the user.

All tags entered in the client and uploaded to the client from the server are stored on the client relative to the caller with indications of when it was created, edited or deleted, and an indication of if it was deleted. The same tags are stored on the server for backup and synchronization associated with that user and propagation to other users.

“System” tags are non-editable and may appear as properties of the contact in the user interface, instead of as text tags in the classic sense of tagging.

The Value Scale is a measurement, based on a number of factors that help the callee determine whether to answer the call. A non-exhaustive list of typical factors would include: Personal (to the callee); network, based on behaviors or actions of the network of people that callee belongs to; and public, based on publicly available relevant information.

Examples of positive personal factors may include: the length or volume of prior calls; prior commitments to to-dos or appointments from either party during or at the conclusion of prior calls; prior call purpose or intention notes left by the callee indicating the intention of the caller; a recent prior call by the callee to the caller where he left a message and left himself a note; tags that can interpreted as reflecting positively on the caller (e.g., “great guy”); explicit ratings of prior conversations (e.g., 5-star ratings) as good. Factors that may weigh negatively upon the likelihood of accepting a call may include whether the caller has been marked as spam, or has been blocked, in prior conversations; whether there have been numerous short calls or ignored calls from the caller that the callee has not returned; prior call purpose or intention notes left by the callee indicating the intention of the caller; tags that reflect negatively on the caller (e.g., “dumb guy”); explicit ratings of prior conversations (e.g., 1-star ratings) as bad.

Processing and evaluation of the simpler user-based factors, such as a caller having been marked as “spam,” is done at the client. Tags are sent to the server for analysis. More sophisticated processing of user factors, as well as the network analysis of factors, is done at the server.

Network factors are aggregations of positive and negative personal factors that have been made about the caller either by people who are in the callee's circle of contacts, by organizations of which the callee is a member (such as a company or school), or by the network as a whole (e.g., numerous users blocking a cold-calling spammer).

Public factors may include news or publicly available information indicating that the caller is a person of fame, power, position or stature, or that the person is of disrepute.

Such factors may be represented at the time of an incoming call either by a graphical scale such as a progress bar, level gauge or a fuel gauge, or by color, text, or a combination of graphical representations reflecting the major factors. The callee may be able to drill into those factors to learn more about them.

Either during or at the end of the phone call, the user may note the caller's purpose or intention, the caller's name, position, or company, the caller's tags. In addition, the user may mark the call as spam, block the call, make a list of to-so items, calendar appointments, make notes, or rate the call (e.g., 1-5 stars).

Such information may either be saved on the local client or sent to the server for further analysis or, in the case of to-do items and calendar appointments, forwarded to the appropriate services or servers of the user's choosing through mechanisms such as APIs or e-mail. To-do items and appointments may be sent to the caller as well as to individuals whom the callee designates (e.g., send a to-do to an administrative assistant) via e-mail, SMS, instant messaging or through 3 party systems such as CRM systems. In the event that the callee and caller have the same call information system, any to-do or appointment items may be simultaneously recorded on each party's system.

### BRIEF DESCRIPTION OF THE DRAWINGS

FIG. 1 is a flowchart showing the overall process for retrieving and displaying information to assist a user in deciding whether to accept an incoming telephone call.

FIG. 2 is a flowchart showing detail of the Merge Caller Data component 111 of FIG. 1.

FIG. 3 is a flowchart showing detail of the Calculate Call and Caller Value component 112 of FIG. 1.

FIG. 3a is a flowchart showing detail of the Calculate Call Value Components 301 of FIG. 3.

FIG. 3b is a flowchart showing detail of the Calculate Caller Value Components 302 of FIG. 3.

FIG. 4 is a flowchart showing the flow of data during synchronization and storage of information throughout the system of the invention.

FIG. 5 is a flowchart showing information retrieval and display to a user upon the occurrence of a specified event.

FIG. 5a is a flowchart showing detail of e-mail retrieval 508 of FIG. 5.

FIG. 5b is a flowchart showing retrieval, modification, and storage of other relevant items of information 505, 506, 513, 516 of FIG. 5.

FIG. 5c is a flowchart showing the sending of a follow-up e-mail message expanding on 563 of 5b.

FIG. 6 is a flowchart showing the analysis and propagation of tags and purpose on the server.

FIG. 7 is a flowchart showing the steps taken to determine whether a user is a member of a group and to identify any group of which the user is a member.

FIG. 8 is a flowchart showing the steps taken to determine whether a user has been exposed to specific advertisements.

### DETAILED DESCRIPTION OF THE PREFERRED EMBODIMENTS

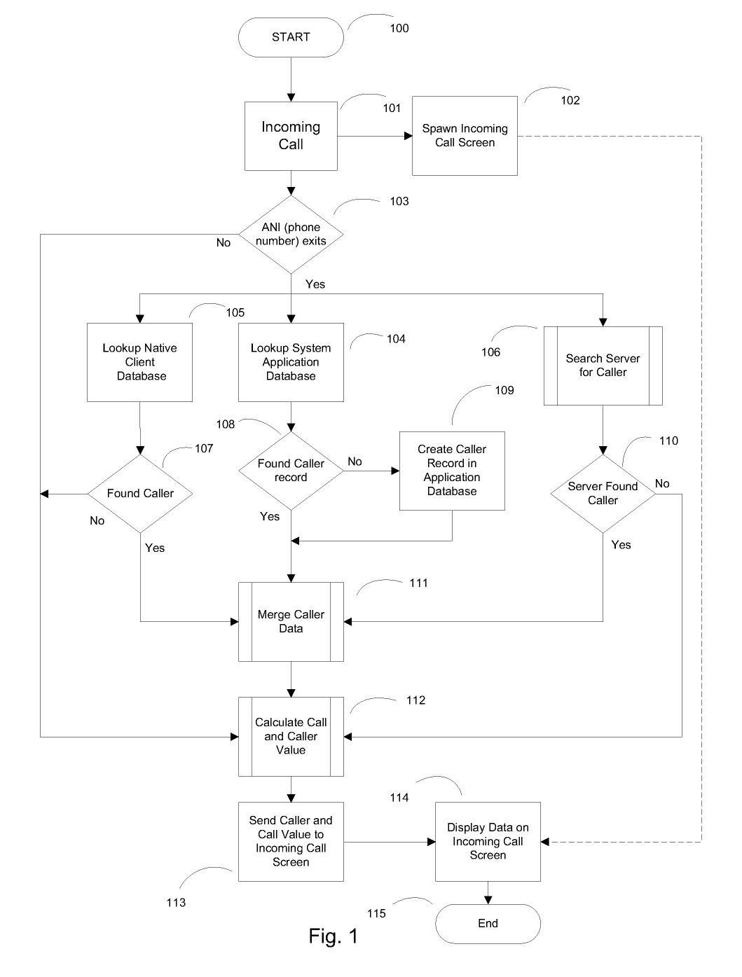

As shown in FIG. 1, one of the purposes of the invention is to determine the identify of the caller of an incoming call and to provide the callee with an assessment of the importance of taking the call. This is done by assessing both the perceived “value” of the caller and of the call, based upon preexisting information that is available to the system. To assist the system in making an assessment, a number of databases may be accessed to obtain relevant information. Preferably, databases may be located on the client device (a “native client database”), within the system application (the “system application database”), and on a main server (the “server database”).

An Incoming Call (101) event will be detected on a device operating platform (“the client”). Such a platform could be a mobile phone, such as Limited Device Configuration (CLDC) devices, a Windows Mobile device, a Google Android, J2ME device, a Symbian OS device, a device running Linux, a full fledged personal computer (PC) voice over IP (VOIP) platform such as those running the Microsoft Windows, Apple Mac, Linux or UNIX operating system (OS), or any other suitable platform. Upon receiving an incoming call event (101), the application spawns an Incoming Call Screen 102 and displays the Incoming Call Screen (114) to a user. Preferably, the application will spawn the screen asynchronously in its own thread, or it may bring the screen to the fore or make it visible. Simultaneously, the application will retrieve the incoming caller's Automatic Number Identification (ANI) from the phone controller (103) if the ANI exists.

If the ANI is found, a set of actions will be invoked concurrently and asynchronously to obtain information relevant to the ANI. A lookup for the caller identity based on the ANI will be performed on the native client database 105, the system application database 104, and the server database 106. If the client's contact identifier is known, the lookup will include the identifier for the caller.

If the caller identity is found in any of the databases, that and any other related, information, will be forwarded to the merge module 111. If the ANI is not found in the native client database or the system database, a negative response will be forwarded to the merge module. If the ANI is not found in the application database, a new caller record and identity will be created 109, and that information will be forwarded to the merge module 111.

The merge module 111 will receive responses from all databases and will merge caller identity data and related information from the databases into a coordinated output for delivery to the call and caller value module 112.

Upon receipt of the native client database response and the application database search, the merge module process is started. Caller data may include, but is not limited to, information such as caller name, title, organization, other phone numbers, e-mail, known descriptive Tags, photograph, and instance messenger IDs. This information is sent to the incoming caller screen 114. The receipt of information from the server database is not a prerequisite for application control to pass to the next step of preparing the call and caller values 112, or displaying the information on the incoming caller screen 114. If server data should be received after the native database and application database searches and merge have been performed, the server's data may be merged in later, and the follow-on steps will be updated, along with the output to the screen. The steps of merging call identity and contact information from multiple databases ensure that the system achieves the most accurate current caller information.

The application includes the processes of calculating call and caller value 112. Call value is a scaled, ordinal value that is assigned to an incoming call, providing this call with a relative degree of importance relative to other actual or potential calls. Caller value is a scaled, ordinal value of assigned to the incoming caller, and places a relative importance upon this caller with respect to other potential callers. The results of the call and caller values are sent to the incoming caller screen for display 114.

The display preparation module 113 receives caller identity data and call and caller value data and presents it on the incoming call screen 114.

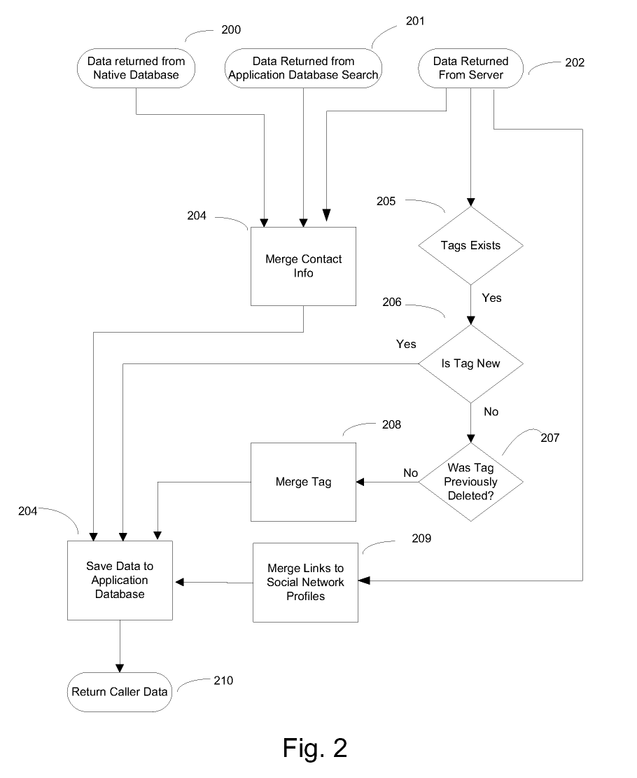

FIG. 2 depicts the flow of information in the merge module 111. Although FIG. 1 depicts the system of the invention with respect to an incoming phone call, the merge module 111 is capable of accepting inputs from a variety of databases and merging them into a usable output, regardless of the initiating event.

When data is returned from the native database 200, it is passed to or collected by a merge function 203 where it is merged with information from the application database 201. Should there be data from the application database but not from the native database, the application database data is prepared for presentation. In the event of a conflict between information from the native and application databases, the native database information will normally be used, following the premise that it will have been more recently entered, hence is more likely to be current. The contact data that is synchronized may include, but is not limited to, names, title, organization, phone numbers, e-mail addresses, instant messenger IDs, photographs, and country code.

As results from the server are returned 202, the merging of that data and resultant determination of which contact information is saved or displayed 203 is determined by timestamps on data from the application database and from the server database. Whichever date is most recent takes precedence. Once data has been merged from at least the native database and the application database, the results may be saved to the application database 204.

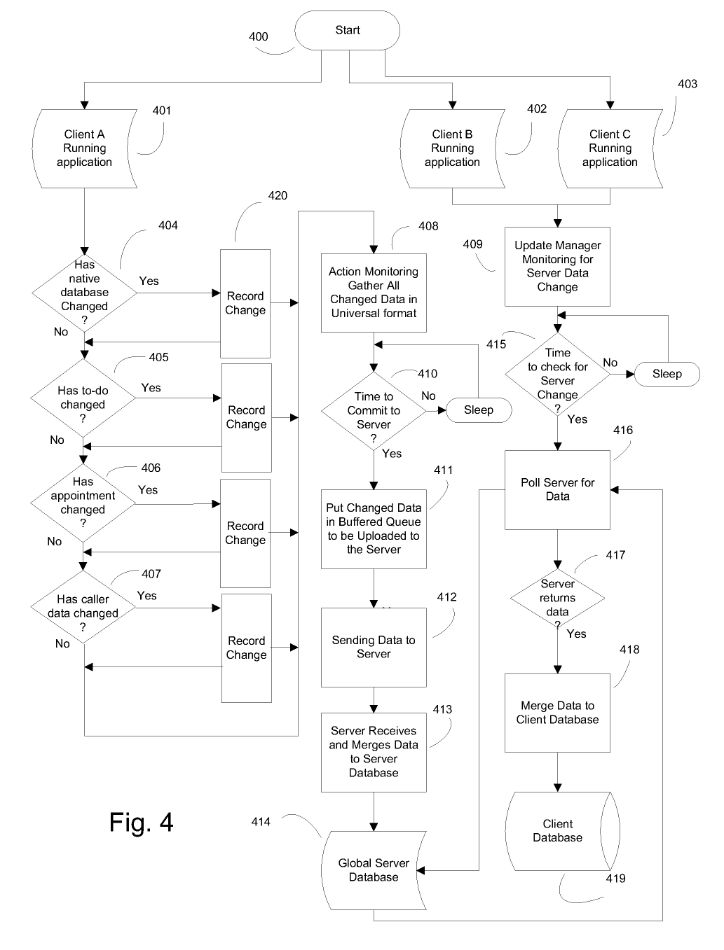

One type of information that may be returned from the server are tags. Tags are defined generally as short descriptive text strings categorizing an individual. An example of a tag would be “MIT” or “developer” or “family”. If a tag exists on the server 205, it will be checked to see whether it is new 206 or was previously deleted from a client 207. This is done since tags are stored both in the application database and also on the server, and it is possible that tags entered by people other than the user may previously have been loaded and deleted. If a tag has been deleted, it is not actually removed from the application database, but is marked as deleted with a timestamp so that, if it should be reloaded from the server, the merging process 207 can recognize that it has been deleted and cause it not to be shown again. Alternatively, the server may not send deleted tags, when a tag had been previously returned to the server during the synching process (see FIG. 4) if flagged as deleted.

Tags and social networks are saved to the application database 204.

When links to social networks profile pages are retrieved from the server, they are merged 209 as an overwrite on existing links.

The merging sub-process concludes when the merged caller data is sent to the calculate call and caller value module.

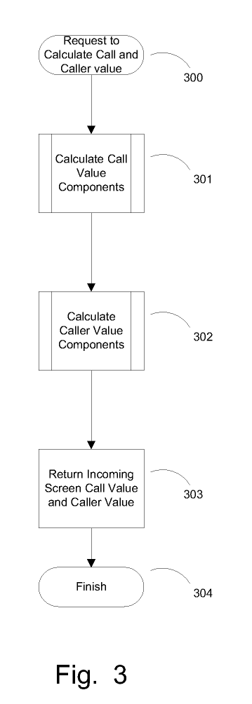

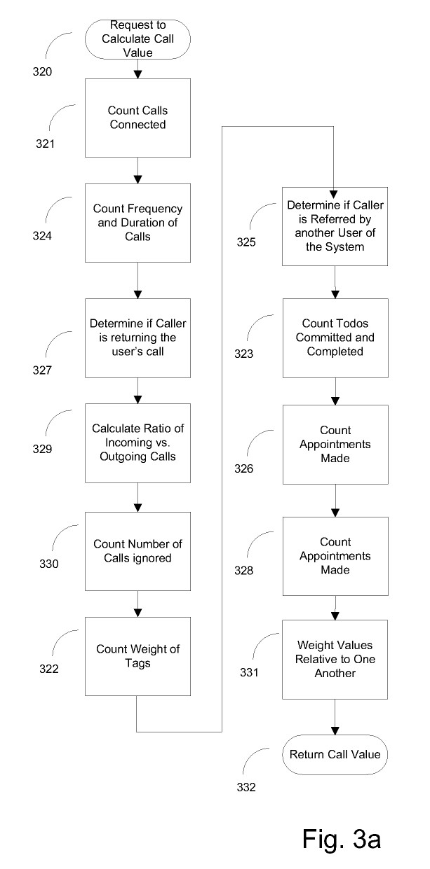

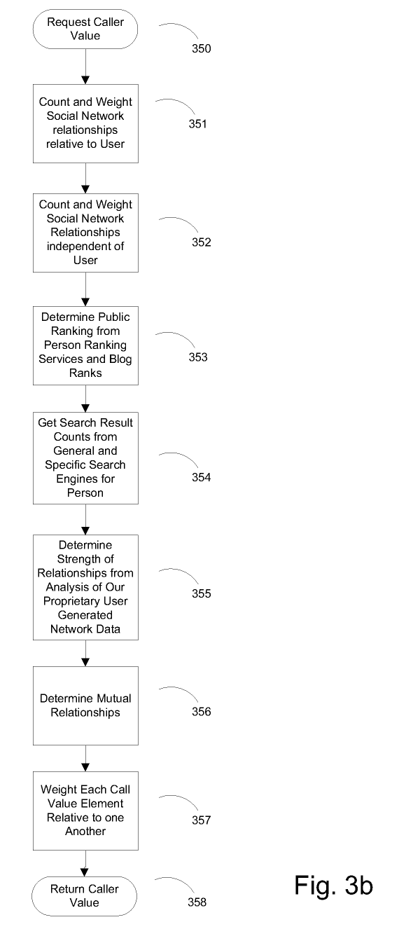

The call and caller value module 112, depicted in FIGS. 3, 3a, and 3b, determines, calculates, and presents a call's value and caller's value based on a number of factors. The process starts with a request to calculate the call value and caller's value 300. The call's “value” is a determination, based on the relationship between the caller and the user, of the likely value of the call 301. As is shown in FIG. 3a, when a client requests a calculation of the call value 320, a number of factors may be considered to determine the strength of the relationship and the likelihood that the user will want to answer the phone. A non-exhaustive listing of factors that may be used to determine a call's value includes the following:

Counting the number of calls that have been answered 321;

The duration and frequency of prior calls 324

Whether the user recently called the caller and thus the caller is returning his call 327

Determining the ratio of incoming vs. outgoing calls 329

Counting the number of calls that have been ignored 330. This factor may have enhanced importance if the caller has called numerous times recently, and the vast majority of those calls have been ignored.

Tags may be used to accord a weight to a call 322. Each caller can be tagged by the user or have tags applied that come from the network. Some of these may indicate a positive relationships, such as “mother”, “brother”, “co-worker”. Some may indicate a negative relationship, such as “spam” or “block”. Some tags may indicate shared relationships, such as a college that the user and the caller both attend or attended. Internationalization, per i18n of these terms is performed by maintaining a list, loadable from the server, where the tags are stored of both the tag and the language of that word. When the weight is calculated, the algorithm looks at the list, filtering for the preferred language of the user.

A caller may have been expressly referred by another user of the system. If so, that would indicate that the caller has a relatively high value 325. That value may also be weighted by the value of the referrer.

If the caller and the user have made prior commitments to perform tasks for each other, that fact indicates a stronger relationship. The count of prior commitments is used to determine value 323. Also considered in this calculation is whether commitments have been completed or whether one party has committed to items for the other party but not visa-versa.

If the caller and the user have committed to meet, or have met, that fact indicates that their relationship 326 may have a value that is quantifiable.

If the caller and user have exchanged e-mails or other forms of messages, that factor may suggest a quantifiable value to their relationship 329.

Once these factors have been determined, they may be weighted and that weighted figure is summed and scaled to a fixed index 331. The scaling may not be absolute as certain factors may play off one another—for example, the caller does not have a call history, but there have been recent e-mails—which might indicated a likelihood of a high call value. That value that is determined from an assessment of all relevant factors is then returned for integration with the caller value 332.

In a preferred embodiment, the calculation of most of these factors is done after a call is completed or information regarding the caller is reviewed and saved, to be retrieved the next time the caller calls. Certain factors, though, lend themselves to be calculated at the time the call is being initiated, such as whether other calls were recently ignored, or whether there were recent e-mails received.

The steps for determining a “caller's value” are shown in FIG. 3b. This process attempts to determine the likely importance of the caller in the larger world, primarily based on relationships and the known behavior of the caller relative to people other than the user 302.

The caller's value as a person is more heavily determined by non-behavioral factors than is the call value. Information may be directly cataloged from the caller's pages on social networks or blogs, or may be obtained from clearinghouses who collect such information in an off-line activity.

Callers who either have direct relationships with the user in social networks, such as Facebook or LinkedIn, or who belong to the same social or affinity groups, are likely to have greater value to the user than callers with no such relationships. Relationships are measurable and quantifiable through requests to the API of such social networks or through clearing houses of social networking data. The system of the invention may make such requests in an attempt to determine the existence and strength of any such relationships 351.

Certain callers may have a very large number of relationships or “friends” within social networks. The fact of a large quantity of relationships may be an indicator of the person's value 352. Other callers may publish their opinions and statuses on blogs or instant mini-blog feeds, such as Twitter. Blogs and mini-blog feeds readership are ranked and cataloged by a number of companies. Since high readership may indicate high value and respect, the system of the invention may check rankings for people who have blogs or mini-blogs 353.

People who are important or popular generally have more news articles written about them, and more references on the Internet, than the average person. While news articles and internet “hits” are not necessarily a strong indicator of importance, the quantity of search results for such individuals may have some bearing upon the value assigned such a person, and may be included in an assessment of value 354.

Proprietary server databases may be programmed to collect information regarding a person's relationships with others across the network through the same methods described for determining the value of a call 355. Information from such proprietary databases can be used to determine the quantity and strength of mutual relationships that the caller's contact list shares with the user, or that the caller shares with the user's contact list. Strong relationships among shared contacts may indicate a quantifiably important caller 356. Each of these factors may be multiplied by a weighting factor relative to one another and scaled to a common scale 357. The resultant value is then returned to the user 358 to assist the user in deciding whether or not to accept a call.

In a preferred embodiment, most of the processing activity will be performed on the server on a periodic basis, with the results being cached and maintained ready for uploading to the user when requested or triggered by an event. The results will then returned 303, and passed to the screen, sent to the client, or cached, as may be appropriate.

The data synchronization and storage subsystem, shown in FIG. 4, demonstrates the method of (a) a client backing up the caller data states into storage on the Server; and (b) synchronizing caller data states with a set of clients, all belonging to the same user. An example of the latter would be where a user has a mobile business smart phone (client A), a mobile personal smart phone (Client B) and a VOIP application running on a Windows desktop (Client C), all running the application system of the invention.

In FIG. 4, 2 or more clients 401, 402, 403 are running concurrently and continuously. Client A 401 is an instance of an Application client running continuously. If a user Contact in the native address book (database) on Client A is added or edited 404, the changed data is formatted into a platform agnostic data exchange format such as XML and temporarily stored in a local memory buffer 420 until dispatched to the Action Monitor 408. Similarly, if a user to-do (task) item in Client A is added or changed 405, the changed data is formatted into a platform agnostic data exchange format, stored in buffer 420, and dispatched to the Action Monitor 408. If a user appointment calendar has been added or changed 406, the changed data is formatted into a platform agnostic data exchange format, temporarily stored in buffer 420, and dispatched to the Action Monitor 408. If user application caller data has been added or changed 407, the changed is data formatted into a platform agnostic data exchange format, stored in buffer 420, and dispatched to the Action Monitor 408. Each of these steps will be queried whenever Client A encounters a change within its database or whenever a system synchronization is initiated.

Action Monitor 408 monitors for data changes, gathers data from temporary storage 420, and formats data into a platform agnostic data exchange format that is ready for dispatch to Server 413. The upload may be sent immediately or may be buffered to be queued. When it is time to commit data 410, the method queues the data 411 for uploading to the Server 413. In a mobile implementation, when wireless signals and an Internet connection are available 412, the client sends data to the Server. The server receives client data from client 413 and updates the data to the Server Database 414. This process may also back up Client A data onto the Global Server Database.

Clients B and C are instances of Application clients running continuously 402, 403. In a preferred embodiment, Clients B and C's update manager monitors the server for server data change 409. When it is time to check with Server for changed data 415, the update manager 409 for Clients B and C will poll the Server for data change 416. If the Server returns data 417, the client merges the returned Data into to Client Database 419.

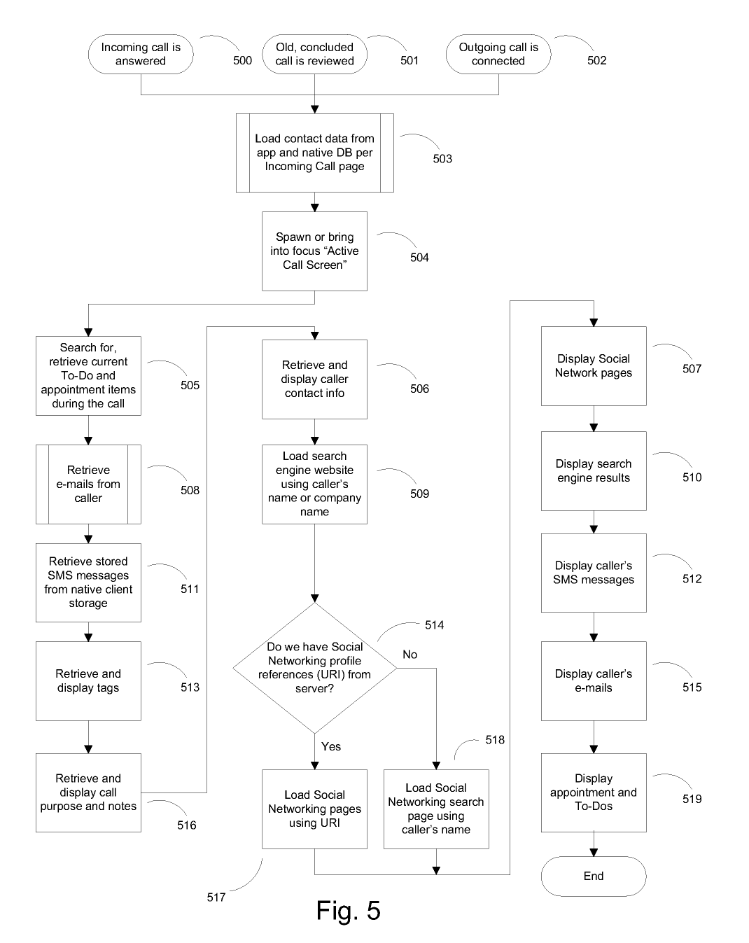

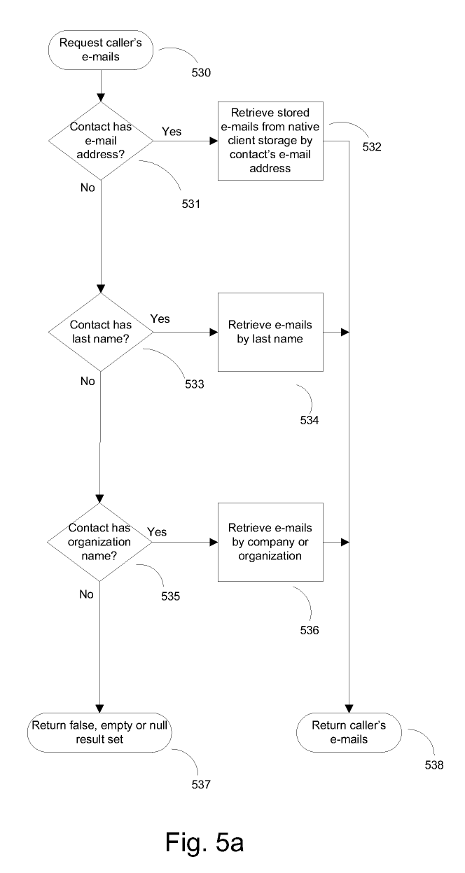

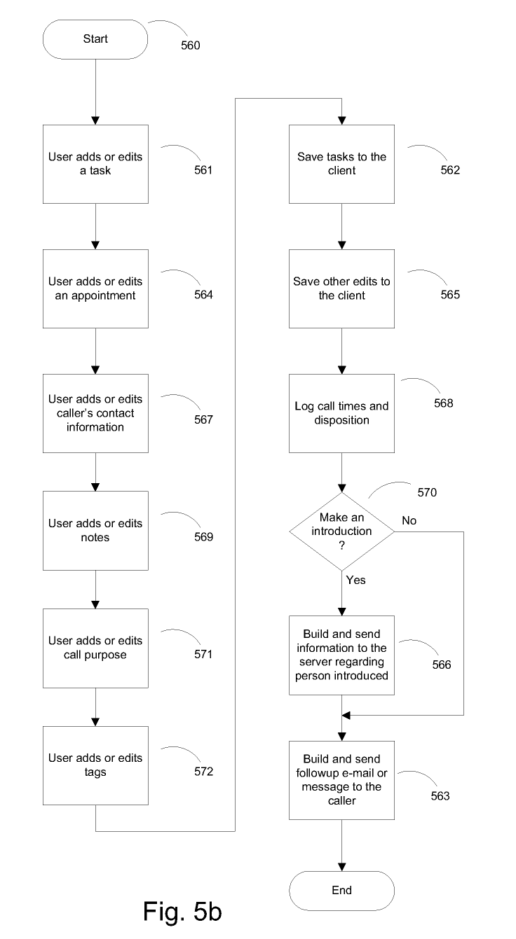

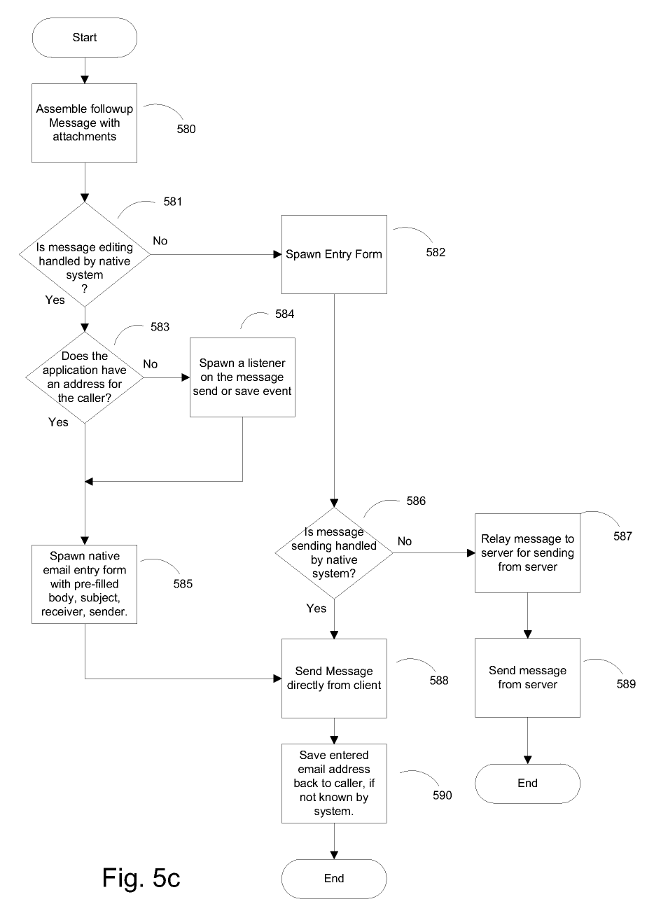

FIG. 5 demonstrates the processes associated with call activity. When an incoming call is answered 500, an old, concluded call is reviewed 501, or an outgoing call is connected 502, the application loads contact data from the application and native databases 503 and spawns the “Active Call Screens” 504 (or brings that previously spawned screen into focus). The “Active Call Screens” are a set of screens, which can be implemented as individual screens or sub-controls or fields in a main screen. All active to-do and appointment items associated with the caller are loaded into application memory from the client's native personal information manager 505. E-mails are retrieved for the caller from the native e-mail's storage location 508.

As shown in FIG. 5a, if the native or application contact information contains an e-mail address 531, the client application searches all e-mails for e-mails to or from that e-mail address 532. If the contact from the native or application databases does not contain an e-mail address, the client application may test to see whether there is a last name 533. If there is a last name , then the client application searches for all e-mails with a to, from, cc or bcc field containing that last name 534. If the contact from the native or application database does not contain a last name, the client application tests to see if there is an organization 535. If there is an organization, then the client application searches for all e-mails with a to, from, cc or bcc field containing that organization 536. Finally, if there is no organization name, then the caller does not have an e-mail address that can be located within the system, and this module returns a null or empty result set 537.

Any e-mails found by the searches are returned 538. The client may then retrieve any sms messages from the native client database, based on the native contact or phone number used by the sms messages 511. The client may then retrieve all tags associated with the caller, along with any colors saved for that tag, and information whether that tag has been deleted or not 513. The client may also retrieve historic notes and call purposes 516 and caller contact information, such as full name, phone number, organization, position 506.

The client may query one or more search engines, such as Google, for the Caller's name or the name of the caller's organization 509. The client may also check to see whether it has references or URIs to specific Social Networking profiles on social networks such as Facebook.com or LinkedIn 514. If there is a reference, then the client will prepare a request for that page 517 and may make a request for that page. If there is no reference, the client will prepare and may make a request for the social network's search page using the caller's name 518. After retrieval of, or references to the above items have been determined, the application will display the items.

The application may also display social network pages 507. In a preferred embodiment, the page will be loaded when the user requests it, as opposed to loading it upon screen load, to save processing time. On phones prior to 3G phones, where concurrent voice and data calls are not possible, the client may cache a page loaded after a prior call.

In a preferred embodiment, the application will display search engine results 510, loading the page when requested. The application may also display the caller's archived SMS messages and conversations with the user 512. From this display page the user has the ability to send and receive new messages. The application may also display a summary of archived e-mails 515. In one embodiment, selecting an e-mail can show the full e-mail or may allow a reply to that e-mail.

In the primary display page, the application may display incomplete to-dos and future appointments 519 made with, by, or for the caller. In a history page, the application displays all recently entered or incomplete to-dos. The user can interact with a to-do item by setting a summary or description as “completed” and by assigning it to the user or the caller 561. In the entry of an assignment, the assignment is indicated as an Object—e.g., performed by “me” or “you.” In the display of the to-do item, the assignment is referred to as a subject “I” or “You.”

As shown in FIG. 5b, when a new to-do or appointment is added from within the application 562 during or after a call, either a reference to that to-do is stored in the client application database or a reference to the caller is stored in the native item's database. In a preferred embodiment, upon saving a to-do, the summary, or whatever text is presented in the phone's native to-do manager's list of to-dos, will be saved with an indication of who the note is assigned to, separated by a separator character. For example, to-do items may be entered as “I—get milk” or “Mike Smith—send documents”. In this embodiment, when an item is entered or read in to the client, if the summary and assignment are not saved in a parallel application specific data structure, the summary will be parsed, and anything starting or ending with the caller's name, or anything starting or ending with “I” or a similar indication of the user himself or herself, will be presented in the user interface as assigned to the caller or the user respectively. In the preferred embodiment, to-do items are stored immediately upon completion of that item.

In the preferred embodiment, appointments can be entered directly or, if appointments are entered during a call 564, the entry is monitored by a listener communicating with the native appointment application. References to the application's caller ID or call context ID are stored either with the native appointment item or else the phone application stores the native appointment ID. In the preferred embodiment, appointments are stored upon completion of the item.

In the preferred embodiment, the active call screen includes the ability to directly enter and manage caller contact information without switching to the phone book application or explicitly “adding a contact” 567. In addition, the user can add or edit notes about the call 569, and such notes will be saved to the caller or call in a chronological format based on the call start time 565. The user can also add or edit the purpose of the call 571. The purpose of the call is also saved in a chronological format, based on the call start time 565. The disposition, length and time of the call are also logged 568.

Also as shown in FIG. 5b, in a preferred embodiment, a user can identify another person in his or her telephone address book (database) to make an introduction 570. If an introduction is made, a message may be sent to the server 566 containing information about the introduction, which creates a caller record on the server for both the person being introduced and the person receiving the introduction. The caller record is saved in each person's respective server-based telephone books (database). Information regarding the introduction is also propagated to the clients using the synchronization procedure. A special tag may be included that carries a high value positive weight. When an introduced person receives a call from the person who received the introduction, or vise-a-versa, the introduction will be displayed on the incoming call screen (113, 114).

Also shown on FIG. 5b, the user can add, edit or delete tags about the caller 572. In a preferred embodiment, the tags will be saved or persisted immediately upon entry. The user can set the colors of the tags, which will set the base color for all occurrences of that tag, even across other callers.

The call time may be logged 568, along with the purpose, notes and disposition of the call, such as “incoming and ignored” or “left message” 562, 565. During or after a call, the user has the ability to trigger the application to prepare an automated e-mail or message (SMS or the like) containing to-dos for either the caller or the user, or both. Future appointments and notes the user wishes to share with the caller can also be added 563. When generating e-mail, the topic, salutations, introduction, message body and signature may be pre-filled from editable templates saved on a per-internationalized basis within the client 580.

If desired, Microsoft Outlook to-do or appointment items may be attached to the file in importable format. The sender and recipient's e-mail addresses will be pre-filled, if known. Depending on the capabilities of the platform and the type of message to be sent, the client will determine whether it can spawn the native e-mail or SMS program for message entry or, alternatively, whether it needs to create its own message 581. If the message is handled by the native system's built-in client, and the caller record does not contain the caller's e-mail 583, then the application will spawn a listener thread 584 that will listen to the sending or saving of the e-mail, and will collect the e-mail address and saved it back to the caller 590. This process is shown in FIG. 5c. If the application has the caller's e-mail, or the listener has been created, then the native entry form may be spawned or brought to the fore, with the message pre-filled in 585. Otherwise, the client application may spawn its own entry form with the message pre-filled in 582.

If the message can be sent by the client, the native message application will send the message directly upon a user command, or the client application may send the message using the client's native API 588. If sending of the message is not handled by the native system 586 then the message will be relayed to the server for sending 587. In that case, the server will send the message according using the best protocol 589. The protocol is determined by the preferences of the user, and the capabilities of the caller.

If the e-mail address was not known at the time the e-mail was assembled, and the message is sent or saved, then the e-mail address will be saved back to the caller record 590.

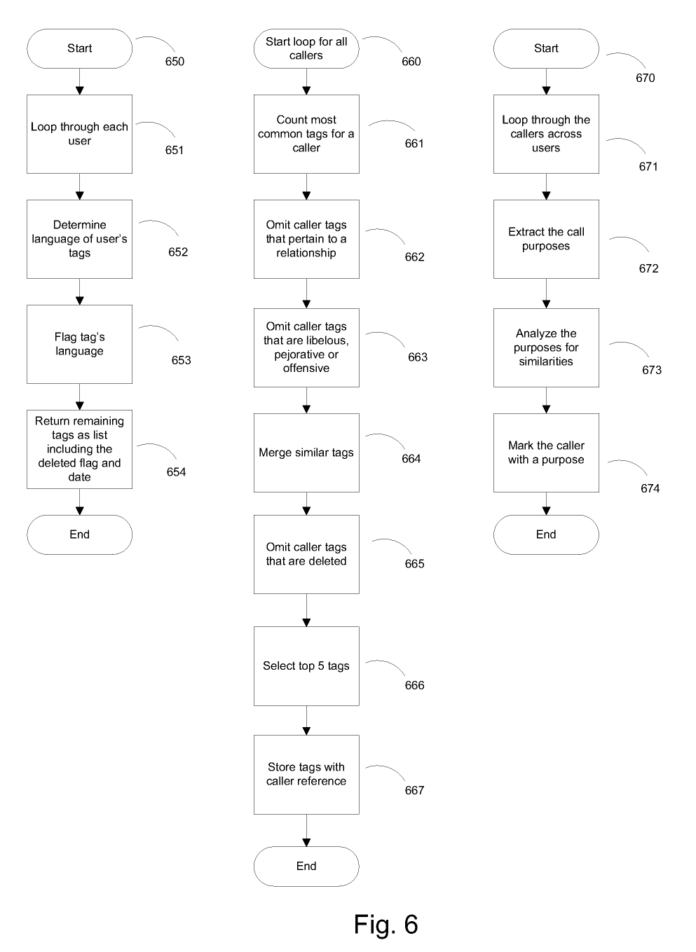

FIG. 6 depicts a series of flow paths demonstrating the management of server tags and call purpose information. While users may enter any text in a tag or purpose to identify an individual, only some of those tags are intended for propagation to other users. The analysis of which tags and purposes to propagate is performed on the server.

In a first pass 651, all user records are reviewed to assess the specified language of the user, and to make a dictionary analysis of tags, notes, and other entries of the user 652, to determine the most likely language for tags. Each tag is flagged with its most likely language 653, and a list of tags, including any deleted flags and deletion dates, is returned.

A second pass through all callers 660 combines and counts all tags 661, omitting those tags that pertain to a relationship between the caller and callee (e.g., “brother”, “co-worker”, “tenant”). This is because relationships are relative to the two parties, and are not transitive to other parties. Tags are also omitted where, based on a dictionary analysis, those tags may be libelous, pejorative or offensive 663. Tags that may be substantively identical but are spelled differently (e.g., abbreviations vs. full names, single vs. plural, synonyms) may be merged 664, based on a lexical analysis. Tags that has been recently deleted by a significant number of people are likely to be no longer valid. This step will remove tags which have had a statistically significant number of deletions 665.

Once these filtering analyses have been completed, a small quantity (e.g., 4 or 5) of the most popular tags, such as those having a count of entries above an amount that indicates widespread acceptance of the tag, will be selected 666. A simple implementation of this mechanism might be that tags shared by fewer than 5 people should not be propagated. The selected tags are stored and cached in the server for easy retrieval in the future by clients 667.

The thresholds for propagating purposes are much stricter. In this pass, the system loops through the call purposes across the network for a single caller, and analyzes the purposes for similarities. If there is a high probability of a quantification of the caller's purpose, then the caller record is marked with the purpose. The likelihood of correctly identifying a purpose is enhanced by tagging a caller with certain tags, such as “spam.”

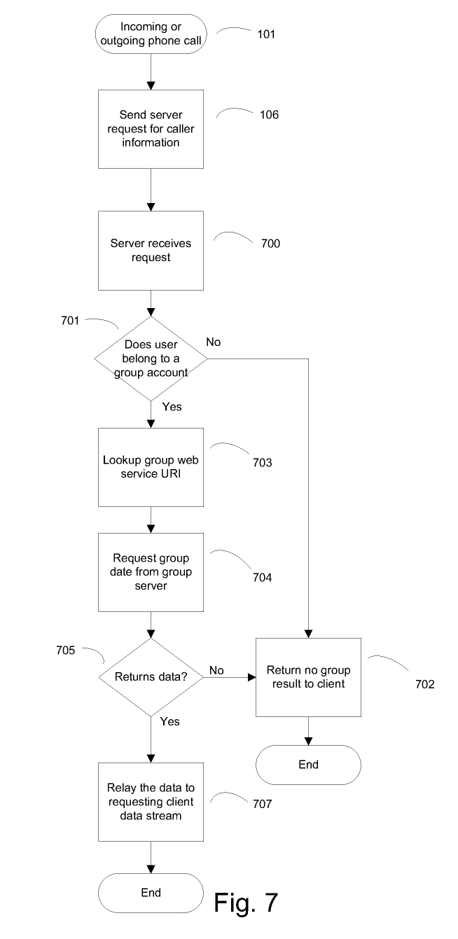

A flow chart depicting handling for group connectors is shown in FIG. 7. Group Connector allow a client to belong to a group which defines, maintains, and controls access to private or proprietary data. The group may be either a formal membership, such a division of a company, or an informal relationship, such as a group of friends.

Upon the event of an incoming or outgoing call 101, the client will send a request to the server for more information about the caller 106. The server receives the request 700 and checks to see if the user belongs to a group account 701. If the user does not belong to a group account 702 then the server's standard response, absent any information from group accounts, is returned. If the user belongs to a group account, the system retrieves the URI of the group account's web service 703, along with any authentication or security credentials required. These credentials may take the form of username and password, public and/or private keys, or other standard security mechanisms.

If the group is running a web service, the server sends a request, either synchronously or asynchronously, to the group's web service containing either a phone number of other identifier 704. If there is no relevant data or no response, the server will either send a negative response to the client, or no response 702. If the group server has any relevant data, it will return the data to the calling server, and the calling server will relay that information to the client 707. If the caller belongs to multiple groups, the server may merge the data before returning it to the client.

Some of the information returned may be custom calculated caller values which would then be displayed on the incoming call screen. The information returned may also contain to-do tasks, appointments, contact details, notes and other structured data.

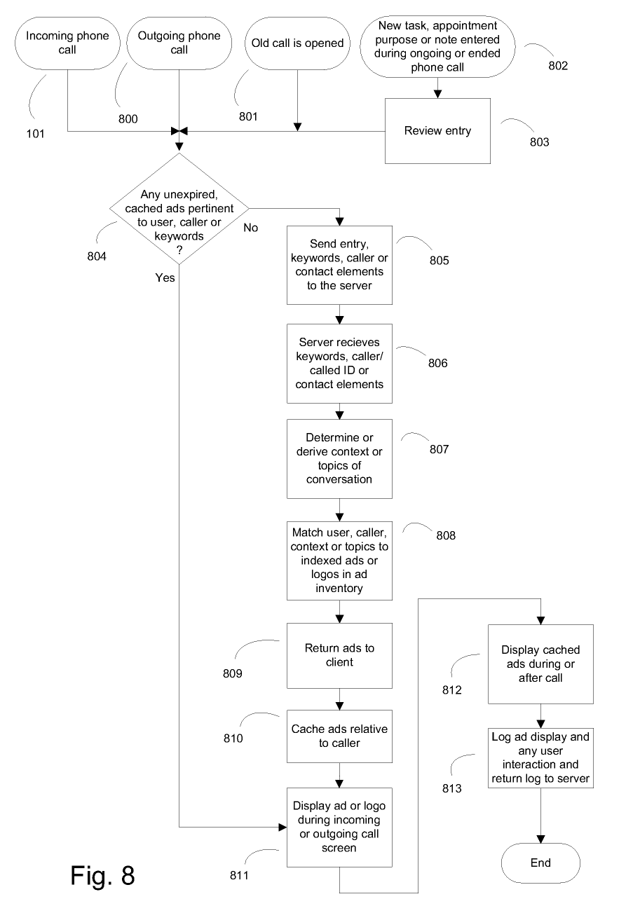

The advertising server process is demonstrated in FIG. 8, and starts when a new call context is established 101, 800, 801, or during or after a conversation, as the user performs text entry within the application 802. When an incoming call is received 101, the client sends the phone number or caller identifier to the server, requesting any pertinent information.

When an outgoing call is made 800, or when the user opens an old call 801, a process is triggered 804 that checks within the client's local advertising cache to see whether there are any relevant, unexpired ads pertinent to the caller, the user, or keywords pertaining to the caller, such as the caller's company. These ads may be in the form of a text ad, or a banner, or simply a logo.

During a call, as the user is entering or reviewing “contextual elements” such as to-do task items, purposes, tags, notes, e-mails or appointments pertaining to the call, the client monitors those entries and views 803, and checks the client's cache of ads for relevant, unexpired ads 803. If there are no ads to show from the cache, then the client may send a request to the server with contextual elements 805 or caller contact information such as phone number name, organization, position or keywords extracted from entered data. Alternately, checking the client cache may be optional, and the request, containing relevant data, may be sent directly to the server 805.

After the server receives keywords, contextual elements, or caller contact information 806, it will analyze the sent information in an attempt to determine the context or topics of conversation 807. This analysis is performed through a combination of keyword matching, grouping of related keywords by context, and trending topics of past conversations for both caller and user. From this analysis comes a list of possible topics with a relevance rating. The server will review the entire ad inventory 808 and will attempt to find the highest revenue generating ads, considering such factors as the ad's prior success as measured by the ratio of prior clicks/prior views, the relevancy of the ad to the user, and the user's past behavior relative that ad or vendor. The ad inventory may contain display or banner ads, images, text ads or company logos.

The ads selected by the server are then returned to the client 809. The ad may be sent with meta-information such as keywords, expiration dates, a measurement of the value or worth of the ad, display times or display locations, company contact information, map addresses, or a reference to said information. The client then may optionally cache the ads relative to the server 810 for future display.

The client may display one or more ads, either individually, or in conjunction with others, or in a series. Display may take place while the call is being connected 811, during the conversation, or during a post-conversation review of a call outside the call environment 812. The client may then log the presentation of ads, along with any interactions the user performs with regard to the ad, such as clicking, looking up an address or map related to the advertising company, entering a task related to the context of the ad, or performing a follow-up call to the advertiser 813. The log may then sent back to the server for aggregated reporting and billing to the advertiser.

It will be appreciated by those skilled in the art that the descriptions and explanations contained herein are exemplary, and that the scope of the invention is not limited thereby, but is limited only by the appended claims.

We claim:

1. On a telephone operating together with a display device on a communications network, a method for obtaining information regarding a telephone call comprising the steps of:
(a) maintaining at least a first database in said network, said first database containing recorded information related to the identity of persons in a telephone address book, said information comprising one or more of a name or a telephone number;
(b) upon the occurrence of an event, searching said first database to determine whether a first telephone number is recorded in said first database;
(c) if said first telephone number is recorded in at least one database, retrieving a first set of information associated with said first telephone number;
(d) if a second database exists in said network, searching said second database to determine whether said first telephone number is recorded in said second database;
(e) if said first telephone number is recorded in said second database, retrieving a second set of information from said second database associated with said first telephone number;
(f) repeating steps (d) and (e) for each additional database in said network;
(g) merging all retrieved sets of information in accordance with predetermined parameters for selecting, prioritizing and sorting said information;
(h) displaying said merged information to a user on said display device.

2. The method as claimed in claim 1 wherein said network includes at least three databases, said first database being maintained in a native device being connectible to said network, said second database being maintained in a software application device connected to said network, and a third database being maintained in a server connected to said network, further comprising the steps of:
(a) if one of said sets of information identifies a person associated with said first telephone number, searching the internet for information related to said identified person;
(b) if information related to said person exists on the internet, retrieving such information from the internet;
(c) merging said information from the internet with all retrieved sets of information being merged;
(d) storing a copy of said merged information onto said database residing on said server and storing a copy of said merged information onto said database residing in said software application device.

3. The method as claimed in claim 1 wherein a web server database resides on a network server, further comprising the steps of:
(a) maintaining on said network a plurality of tags, each tag in said plurality of tags signifying a property that may be assigned to a telephone record;
(b) determining whether said merged information includes a tag;
(c) if said merged information does include a tag, displaying said tag on said display device, or if said merged information does not include a tag, assigning a tag to said merged information;
(d) storing said tag with said merged information on said database residing on said server and on said database residing in said software application device.
